(19) United States
(12) Patent Application Publication
(10) Pub. No.: US 2005/0015465 A1
(43) Pub. Date: Jan. 20, 2005

(54) System and method for client aware request dispatching in a portal server

(76) Inventors: Gregory J. Ziebold, Superior, CO (US); Thomas R. Mueller, Fremont, NE (US); Jeffrey T. Blattman, San Jose, CA (US); Luu D. Tran, Santa Clara, CA (US)

Correspondence Address: OSHA & MAY L.L.P./SUN, 1221 MCKINNEY, SUITE 2800, HOUSTON, TX, 77010, US

(21) Appl. No.: 10/621,846

(22) Filed: Jul. 16, 2003

(51) Int. Cl. G06F 15/16

(52) U.S. Cl. 709/219

(57) ABSTRACT

A method for automatically configuring information display in a client device. A user of a client device submits a request for a resource to a portal server. Information in the request is mapped to a unique identifier by the portal server. The unique identifier is used by the portal server to select an aggregation container that contains a display page with content that is selected and formatted for the particular device associated with the identifier. The user request is then dispatched to the aggregation container, and the page specified by the container is delivered to the requesting client device.

### RELATED U.S. PATENT APPLICATIONS

This Application is related to the following commonly-owned, co-pending U.S. patent applications: “Hierarchical Client Detection in a Wireless Portal Server,” by Kavacheri et al., filed on ______, Ser. No. ______, Attorney Docket No. SUN-PO30067; “Hierarchical Client Aggregation in a Wireless Portal Server,” by Ziebold et al., filed on ______, Ser. No. ______, Attorney Docket No. SUN-PO30068; “Extensible Customizable Structured and Managed Client Data Storage,” by Kavacheri et al., filed on ______, Ser. No. ______, Attorney Docket No. SUN-PO30090; the contents of which are incorporated herein by reference.

### BACKGROUND OF THE INVENTION

1. Field of the Invention

This invention relates to portal servers and the provision of services for mobile clients. In particular the invention relates to client aware dispatching of services in response to a request by a client.

2. Related Art

A portal is an entry point to a set of resources that an enterprise wants to make available to the portal's users. For some consumer portals, the set of resources includes the entire World-Wide Web. For most enterprise portals, the set of resources includes information, applications, and other resources that are specific to the relationship between the user and the enterprise. For service providers, the portal provides a point of entry to customer service applications.

In general, a portal enables users to customize the available data content and control how data is displayed. A user may also create and manage links to other allowable web sites. Resources can include the use of provider applications and utilities such as mail, file management, and storage facilities.

Information provided to a client device may be displayed to a user using a graphical user interface (GUI). A GUI display page may contain graphics, text, and hypertext. For wired devices such as workstations and terminals, display sizes do not vary considerably, and a GUI display can usually be adapted for a particular display by selecting a typical display resolution (e.g., VGA or SVGA) and/or selecting a font.

However, the advent of wireless client devices has produced a much greater range of display sizes and capabilities. A handheld wireless device may have a display with a diagonal size of less than three inches, while a portable wireless device may have a display with a diagonal size of greater than 15 inches. For this wide range of display sizes, resolutions, and capabilities, simple changes in resolution and/or font sizes do not provide sufficient adaptability for a GUI across all platforms.

Although the operating system software of a client device may provide a capability for locally configuring the device display, this capability places an undue burden on memory and computational resources that are typically limited in a mobile device.

### SUMMARY OF THE INVENTION

Accordingly, there is a need for a method of optimizing the configuration of information displayed on a client device. There is also a need for minimizing the demands on the resources of wireless client devices while maximizing the configuration flexibility. It is also desirable that the method be invoked automatically (e.g., by a request for a resource), without explicit instructions by the user of the client device.

A method for client aware dispatching in a portal server is disclosed. In one embodiment, a user of a client device submits a request for a resource to a portal server. Information the request is mapped to a unique identifier by the portal server. The unique identifier is used by the portal server to select an aggregation container that contains a display page with content that is selected and formatted for the particular device associated with the identifier. The user request is then dispatched to the aggregation container, and the page specified by the container is delivered to the requesting client device.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a high level diagram of a network architecture in accordance with an embodiment of the present claimed invention.

FIG. 2 shows an interface diagram for the portal server shown in FIG. 1, in accordance with an embodiment of the present claimed invention.

FIG. 3A shows a desktop display for a client device, in accordance with an embodiment of the present claimed invention.

FIG. 3B shows a handheld wireless device having a reduced area display with a browser display provided in accordance with an embodiment of the present claimed invention.

FIG. 3C shows a handheld wireless device having a still smaller display with a desktop page provided in accordance with an embodiment of the present claimed invention.

FIG. 4 shows an overall session flow diagram for a client request and portal server response, in accordance with an embodiment of the present claimed invention.

FIG. 5 shows a detailed computer implemented flow diagram for delivering a configured display page to a client device display, in accordance with an embodiment of the present claimed invention.

FIG. 6 shows a functional block diagram for a portal server, in accordance with an embodiment of the present claimed invention.

FIG. 7 shows a block diagram of a portal server with a mobile portal module, in accordance with an embodiment of the present claimed invention.

### DETAILED DESCRIPTION OF THE INVENTION

In the following detailed description of the present invention, a system and method for client aware request dispatching in a portal server, numerous specific details are set forth in order to provide a thorough understanding of the present invention.

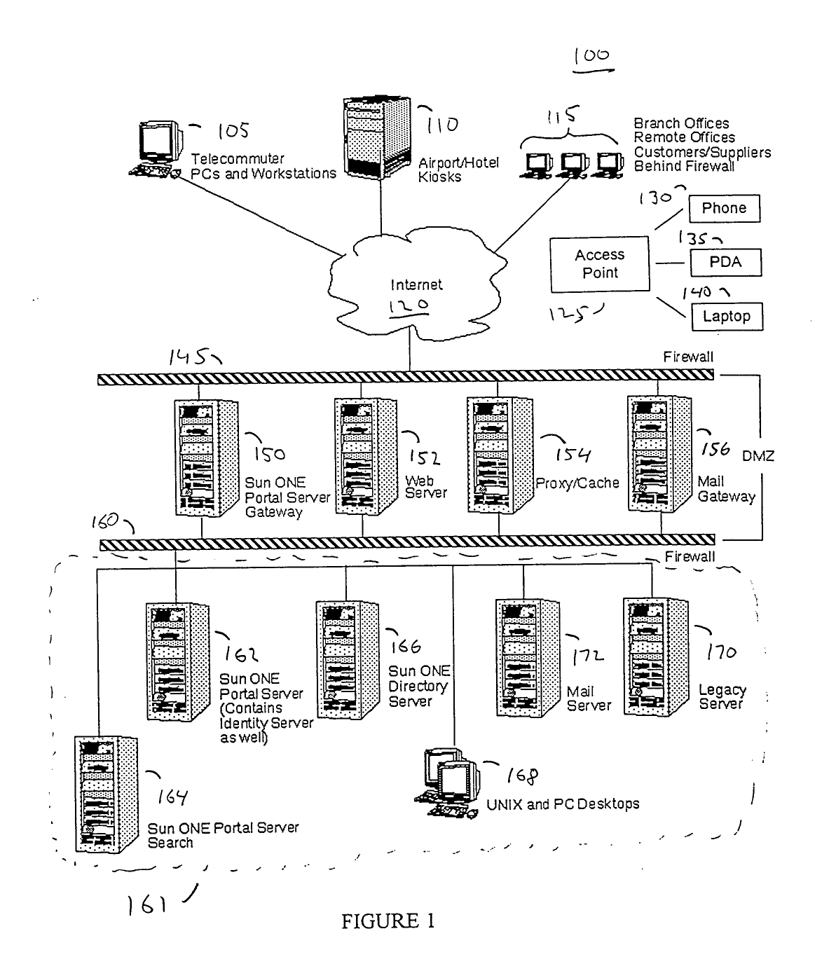

FIG. 1 shows a high-level architectural diagram 100 of a typical network installation. In this example, the gateway 150 is hosted in a demilitarized zone (DMZ) along with other systems accessible from the Internet 120, including a web server 152, proxy/cache server 154, and mail gateway 156. The core portal node 162, portal search node 164, and directory server 166, are hosted on the internal network 161 where they have access to systems and services ranging from individual employee desktop systems 168 to a legacy server 170, or a mail server 172. The DMZ is bounded by firewalls 145 and 160. In general, a network may not require all of the components shown, and may include components that are not shown.

A number of wired devices including telecommuter PCs and workstations 105, kiosks 110, and remote terminals 115 are shown coupled to the Internet 120. In addition, a wireless access point 125 is also coupled to the internet, providing access to the wired network for wireless devices such as telephones 130, personal digital assistants (PDAs) 135 and laptop computers 140. Users on the Internet 120 typically access the gateway 150 from a web-enabled browser and connect to the gateway 150 at the IP address and port for the portal they are attempting to access. The gateway forwards requests on to the core portal node 162, or directly to the service access on the enterprise internal network 161.

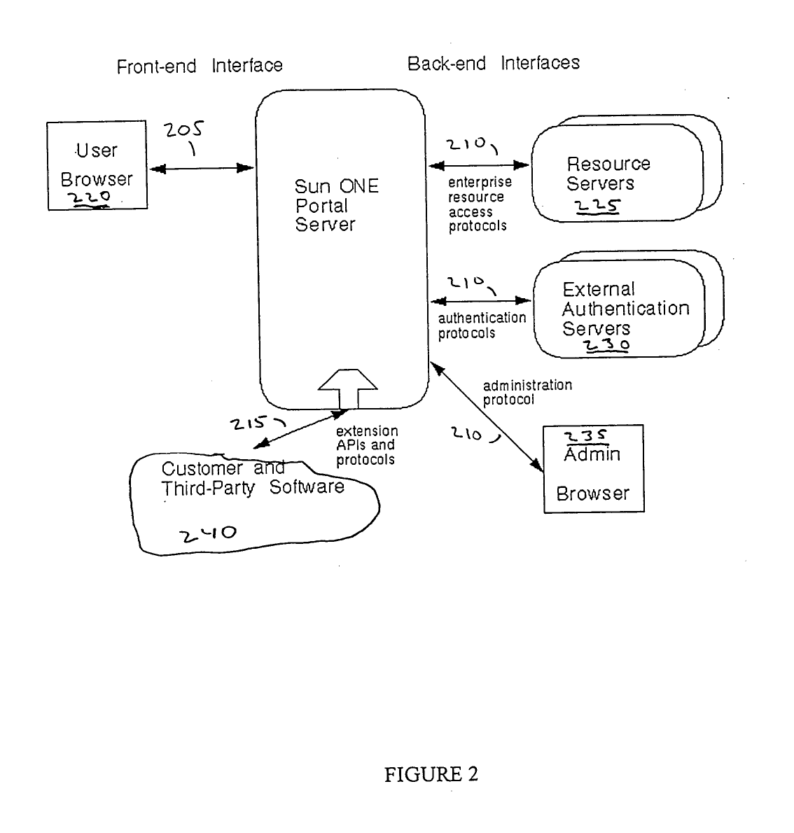

FIG. 2 shows an interface diagram 200 for an example of the portal server 162 shown in FIG. 1. The Portal Server software has a number of interfaces. A front-end interface 205 enables a user browser 220 to access enterprise resource servers 225 (e.g., servers 164, 166 and 168 of FIG. 1) from the Internet 120. The front-end interface 205 uses the hypertext transfer protocol (HTTP) or secure hypertext transfer protocol (HTTPS) with markup languages (such as HTML), JavaScript functions, and Java applets, depending on the application. All of these are standard protocols supported by the most commonly used browser software.

A number of back-end interfaces 210 are used by Portal Server 150 to access the resource servers 225 and to provide the administrative interface to the administration browser 235. The interface to the authentication servers 230 may include authentication protocols such as Radius, NT domain, NIS, or token card.

The interface 210 to the administration browser 235 may include administration console protocols such as HTTP with HTML and other web languages as described with respect to the front-end interface 205.

Examples of protocols used with the resource servers 225 are: Mail (for example, SMTP, IMAP4, and LDAP); file access (for example, FTP, NFS, and SMB); web browsing and information services (HTTP and HTTPS); and calendar (rpc.cmsd and IETF calendar protocols). Customer and third-party software interface 215 is used by customers and third-party software 240, allowing developers to add functionality to the Portal Server system.

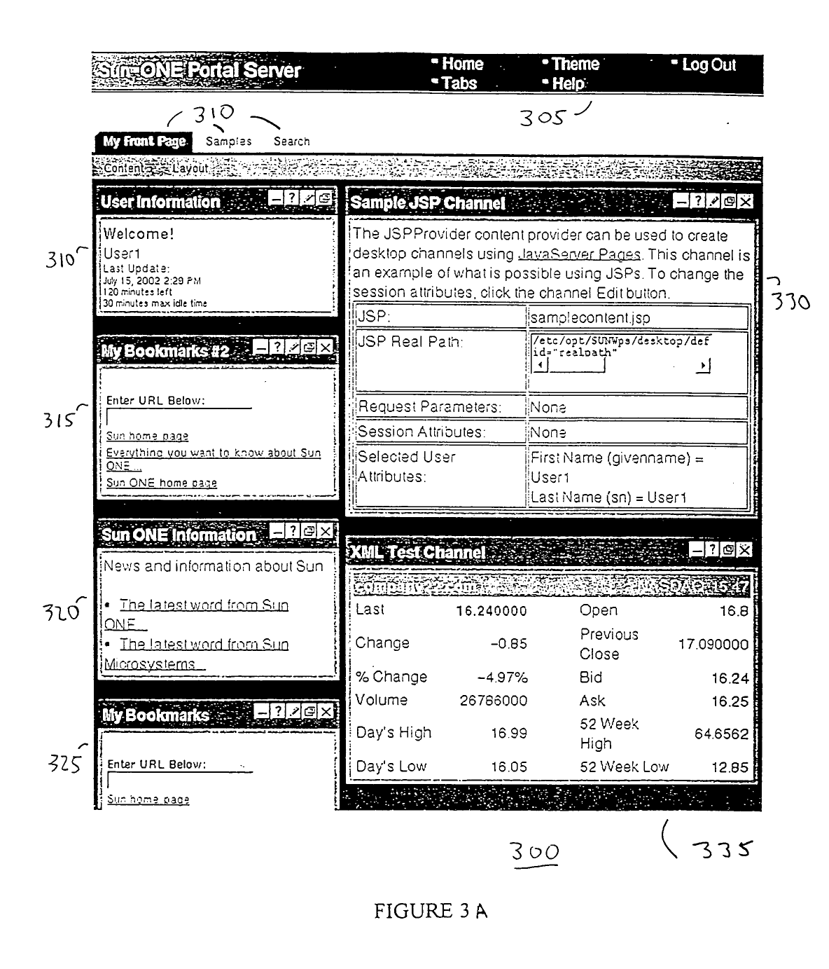

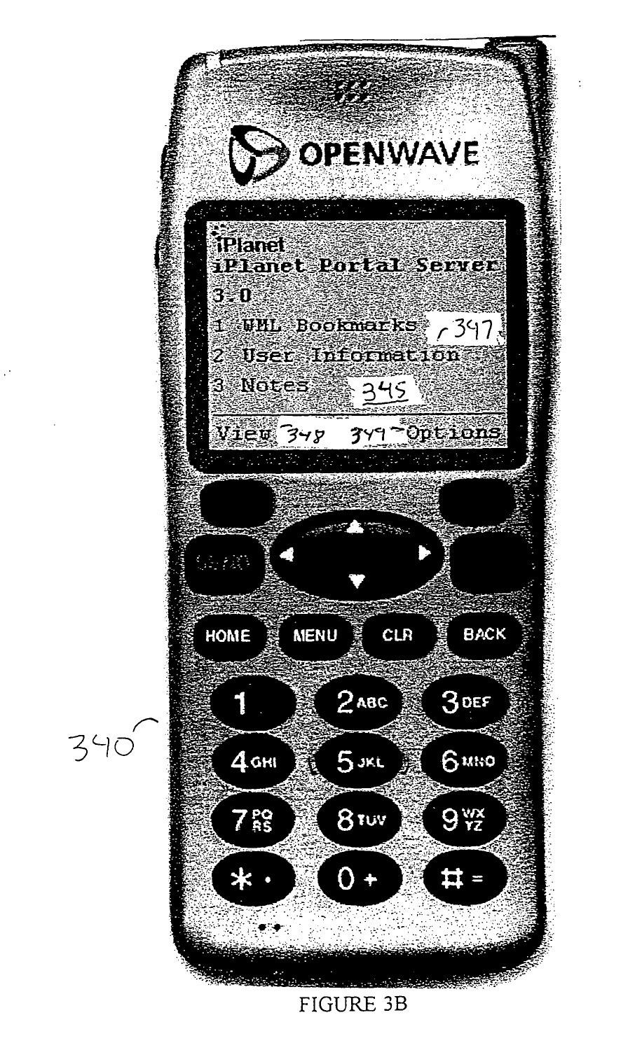

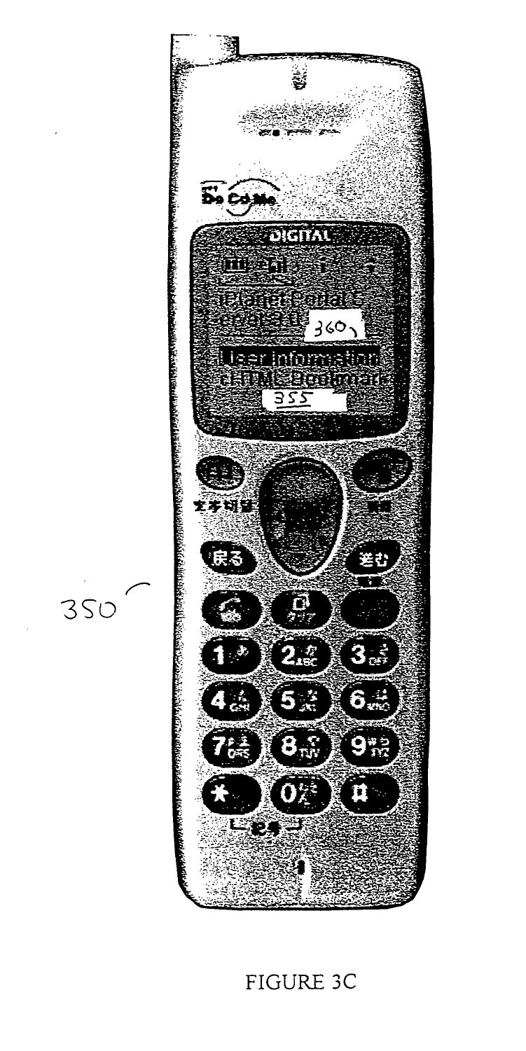

FIG. 3A shows an example of a GUI display, also known as a desktop display 300. The desktop display includes a banner 305, a set of tabs 310, and a collection of five channels arranged in two columns. Channels 310, 315, 320 and 325 are shown in the left-hand column, and channels 330 and 335 are shown in the right-hand column. Each channel provides an access point into some function or information. Users can configure the set of channels that is displayed and specific characteristics of each channel. Channel 310 displays user information, whereas channel 315 and 325 are used to display bookmarks.

FIG. 3B shows a handheld wireless device 340 having a reduced area display with a browser page 345. In contrast to the desktop page 300 of FIG. 3A, which displays the title “user information” and additional text information for the channel 310, the channel 347 of the display page 345 is presented as one item in a menu with three items. The display page 345 also includes “View” tab 348 and “Options” tab 349.

FIG. 3C shows a handheld wireless device 350 having a still smaller display 355, with a desktop page that is limited to a menu with two items, and no tabs. Selection and activation of menu items may be done by using the device keypad. The item 360 “User Information” serves as a link in desktop display 355. In the desktop display 300, the phrase “User Information” is a descriptor for accompanying displayed information.

Each of the desktop displays shown in FIGS. 3A, 3B, and 3C, is client aware. The graphics subsystem, that is display type, of the device that is involved in the session is identified by the portal server, and the initial desktop display provided to the user includes content selected and formatted for the device graphics subsystem that was identified. The graphics subsystem typically contains both hardware and software components. Although the present invention may be used in conjunction with both wired and wireless devices, the greatest benefit is typically achieved with wireless devices.

Both the selection of content for display and the formatting of the displayed content may be involved in aggregating content for display to a user of a client device. With the typically smaller displays found in wireless devices, the information structure may tend to have more levels and links, that is, the characteristics of the display type influence the hierarchy of the aggregated content. In addition to the appearance of the items displayed, the selection and formatting may also associate actions with the items displayed.

Exemplary methods for hierarchical content aggregation are described in co-pending U.S. patent application entitled “Hierarchical Client Aggregation in a wireless Portal Server,” by Ziebold et al., filed on ______, Attorney Docket No. SUN-PO30068.

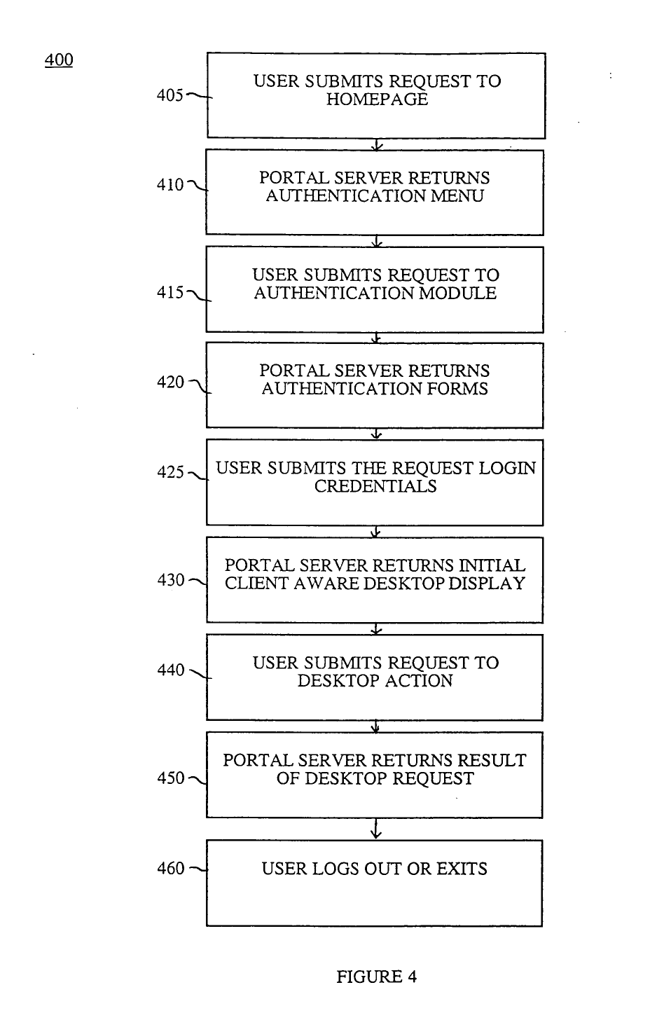

FIG. 4 shows an overall computer implemented session flow diagram 400 for a client request and portal server response. In step 405, a user of a client device submits a request to the portal. In step 410, the portal server returns an authentication menu to the user. In step 415, the user submits request to the authentication module. In step 420, the portal server returns authentication forms to the user. In step 425, the user submits credentials using the authentication forms. Steps 410 through 425 are optional, and may be omitted in non-secure environments.

In step 430, the portal returns the initial client aware desktop display to the user's device. In step 440, the user submits a request to an available action on the desktop. In step 450, the portal server returns the result of the request submitted to the desktop. In step 460, the user ends the session by exiting or logging out.

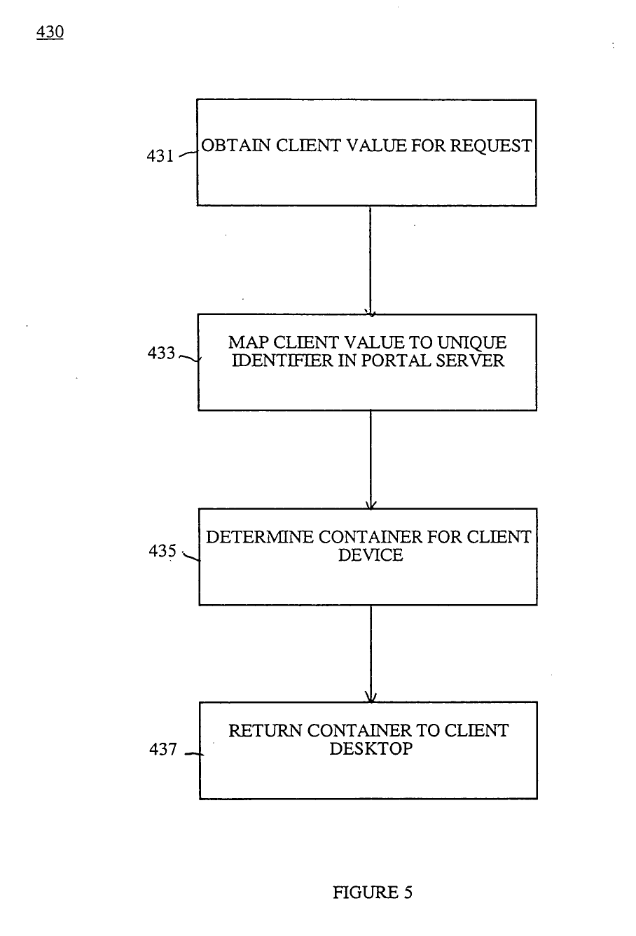

FIG. 5 shows a particular example of a series of computer steps for performing the step of providing of initial client aware desktop display 430. In step 431, A client value is obtained for the request. The client value enables the portal server to identify the user and/or the client device being used for the request. For HTTP, this may be done by using the user agent header of the HTTP request.

In general, the type of graphics subsystem that is associated with the device may be implicitly determined by a prior association with, or registration of, a user with a particular device, or it may be explicitly determined by inclusion in the request.

An example of a process for detecting a client is described in co-pending U.S. patent application entitled “Hierarchical Client Detection in a wireless Portal Server,” by Havacheri and Tran, filed on ______, Attorney Docket No. SUN-PO30067.

In step 433, the portal server maps the client value to a unique identifier associated with the display characteristics of the client device. The mapping allows the information for client aware display configuration to be stored by the portal server, thus relieving the client device of storing the configuration information. In step 435, the unique identifier is used to select the appropriate container for the user's request. The selected container specifies content and its formatting, taking into account the characteristics of the client device display. In step 437, the request is dispatched to the selected container, and the contents are returned to the client device.

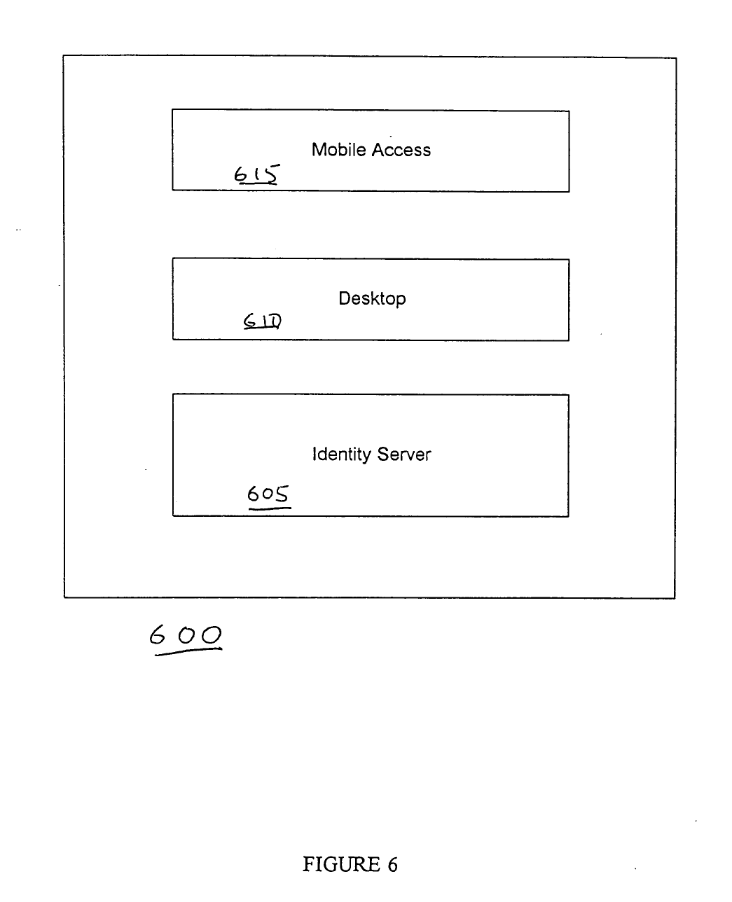

FIG. 6 shows a functional block diagram 600 for a portal server 162, in accordance with an embodiment of the present claimed invention. A mobile access component 615 enables a client device to establish a communications session (e.g., using HTTP). The identity server component 605 provides the mapping between the client device (as determined from the HTTP user agent header) and the unique identifier maintained by the portal server 162. The unique identifier is used by the desktop component to select the aggregation container to which the user request is dispatched. The desktop then returns the page associated with the selected container to the user via the mobile access module 615.

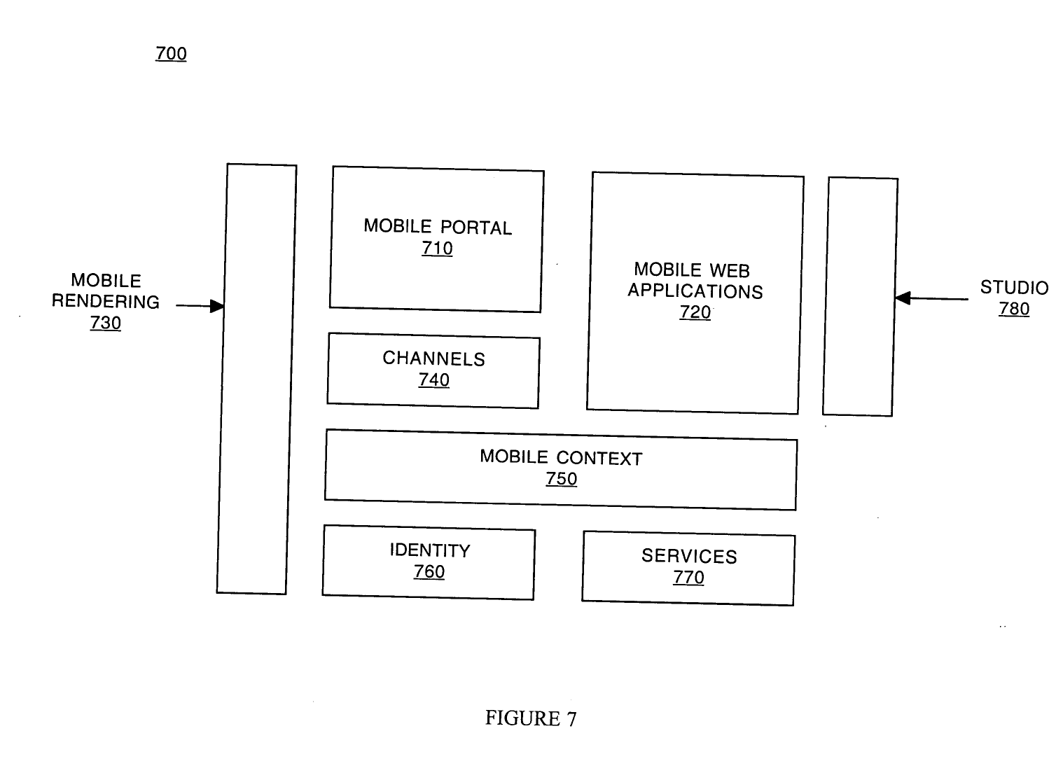

FIG. 7 shows a block diagram of an alternative embodiment of a portal server 700. In the embodiment of FIG. 7, portal server 700 comprises a mobile portal module 710. Mobile portal module 710 displays a homepage for wireless devices accessing the Internet using a web portal. Channels, representing different data services are displayed on the homepage and can be selected based upon user preferences. Mobile portal 710 provides a “micro-desktop” environment for various wireless devices that are connecting with the Internet via web portal 100 as well as a standard desktop environment for desktop computer systems that are accessing the Internet via web portal 100.

Portal server 700 further comprises a mobile web applications module 720. Mobile web applications module 720 provides a standard user interface to application logic that is formatted for desktop computers, as well as a separate “micro-user interface” for mobile devices to application logic that is formatted for mobile devices. Mobile web applications module 720 may provide other user interfaces for other operating environments as well. For example, a “voice-user interface” may be provided to facilitate voice control of application logic.

Portal server 700 further comprises a mobile rendering module 730. In the embodiment of FIG. 7, mobile rendering module 730 is responsible for determining the device type of the mobile device accessing web portal server 100 and for presenting content in a usable fashion to that device. For example, mobile rendering module 730 is responsible for-determining what type of client device is accessing web portal 100. For example, mobile rendering module 730 may determine the manufacturer, and model number of the mobile device (e.g., mobile device 210 of FIG. 2) accessing web portal server 100. Using this information, web portal server 100 can access a database (e.g., database 120 of FIG. 2) to get more specific information about mobile device 210 such as the display size and whether it supports color, buffer size, markup language, type of input device used, etc.

Mobile rendering module 720 also handles pagination of content delivered to mobile devices. Because of limitations in the buffer size or screen size of various mobile devices, content that typically is sent to a desktop computer in one response may have to be sent to a mobile device as a series of discreet messages. Mobile rendering module 720 also translates HTML data into a markup language supported by the mobile device accessing web portal server 100.

Portal server 700 further comprises a channels module 740. Channels module 740 collects data for various services or channels that may be displayed on the user's homepage. In one embodiment, summary information about available channels is displayed on the user's homepage. For example, in an e-mail channel, the summary information may comprise the headers for the first 5 e-mails in the inbox. This simply informs the user that there is mail in the inbox. The user cannot view the mail or manipulate the e-mail application until they click the link to the e-mail channel.

Mobile context module 750 provides information that is shared by the applications and channels offered by web portal server 100 and sets up the environment in which they operate in a mobile context. For example, mobile enabling of e-mail has components in common with mobile enabling of a calendar program. Some of these components include device profiles that may include information with respect to the device graphics subsystem, such as screen size, buffer size, input mechanism, the number of bits-per-pixel (which indicates whether the display is color or black and white), and what languages are supported by the mobile device. Mobile context module 750 also provides service profiles that are specific to the mobile context. For example, a user may utilize a different web browser or e-mail program on their mobile device than the one they use with their desktop computer. Information in the service profile may include the mail server name, port number, login and password, etc.

Identity module 760 stores persistent data such as the user's credentials, log-in password, access privileges to various services, policy information, etc. Identity module 760 also provides a single sign-on capability so that a user does not have to log into various servers separately when, for example accessing e-mail or other web portal channels.

Services module 770 represents the services with which the mobile device can communicate (e.g., e-mail, calendar, address book, messaging, etc).

Studio module 780 provides a developer environment in which users can create custom applications, channels, and interfaces as well as emulators for viewing them on simulated desktops and/or mobile devices.

As described above, web portals generally permit the launching of applications and services from within a portal channel that is usually presented, in an HTML desktop context, as a hyperlink that users select. The channel typically provides summary information about the application with which it is associated, but does not permit manipulation or interaction with the application itself. For example, in an HTML desktop context, e-mail channel 741 may provide the headers of the first 5 messages in the inbox. This tells the user that there are messages in the inbox, but the user cannot view them until they initiate the e-mail application.

While the present invention has been described in particular embodiments, it should be appreciated that the present invention should not be construed as limited by such embodiments, but rather construed according to the below claims.

1. A method for providing a client aware desktop display to a client device, comprising:
receiving a request for a resource from said client device;
obtaining a client value for said request;
mapping said client value to a unique identifier, that identifies a graphics subsystem of said client device;
selecting a container comprising content selection and formatting specific to said graphics subsystem;
dispatching said request to said container; and
communicating the contents of said container to said client device.

2. The method of claim 1, wherein said client value implicitly determines said graphics subsystem.

3. The method of claim 1, wherein said client value explicitly determines said graphics subsystem

4. The method of claim 1, wherein said client value is obtained from an HTTP user agent header.

5. The method of claim 1, wherein said desktop display comprises a plurality of displayed channels.

6. The method of claim 1, wherein said desktop display comprises hypertext links.

7. The method of claim 1, wherein said container comprises content that is hierarchically organized in accordance with said graphics subsystem.

8. A system for providing a client aware desktop display to a client device, comprising a portal server, wherein said portal server further comprises:
a mobile access component for providing a communications session with said client device;
an identity server component for identifying said client and determining a client value, wherein said client value identifies a display type of said client device; and
a desktop component for selecting an aggregation container comprising content configured in accordance with said display type.

9. The system of claim 8, further comprising an authentication server coupled to said portal server.

10. The system of claim 8, further comprising a resource server coupled to said portal server.

11. The system of claim 8, further comprising a mail server coupled to said portal server.

12. The system of claim 8, further comprising a firewall coupled to said portal server.

13. The system of claim 12, further comprising a gateway coupled to said firewall.

14. The system of claim 13, further comprising a wireless access point coupled to said firewall.

15. A computer readable medium containing executable instructions which, when executed in a system comprising a portal server coupled to a client device, causes the system to perform the steps of providing a client aware desktop display to said client device, comprising:
receiving a request for a resource from said client device;
obtaining a client value for said request;
mapping said client value to a unique identifier, wherein said unique identifier identifies a graphics subsystem of said client device;
selecting a container comprising content selection and formatting specific to said graphics subsystem;
dispatching said request to said container; and
delivering the contents of said container to said client device.

16. The computer readable medium of claim 15, wherein said request is made using the hypertext transfer protocol (HTTP).

17. The medium of claim 16, wherein said client value is obtained from an HTTP user agent header.

18. The medium of claim 15, wherein said desktop display comprises a plurality of displayed channels.

19. The medium of claim 15, wherein said desktop display comprises hypertext links.

20. The medium of claim 15, wherein said container comprises content that is hierarchically organized in accordance with said graphics subsystem.
